(19) United States
(12) Patent Application Publication
(10) Pub. No.: US 2003/0190907 A1
(43) Pub. Date: Oct. 9, 2003

(54) Hands-free telephone in dispenser

(76) Inventor: Ervin M. Smith, Monroe, IN (US)

Correspondence Address: RANDALL J. KNUTH, P.C., 3510-A Stellhorn Road, Fort Wayne, IN, 46815-4631, US

(21) Appl. No.: 10/119,259

(22) Filed: Apr. 9, 2002

(51) Int. Cl. H04M 11/00

(52) U.S. Cl. 455/405; 455/406

(57) ABSTRACT

The present invention relates to an apparatus and method for a hands-free communication system for a fuel dispenser connected to a telephony network. The user of the fuel dispenser inputs a telephone number to be dialed and the communication system connects to the telephony network to complete the telephone call. A speaker and microphone are provided so that the user of the fuel dispenser can communicate with the person or place corresponding to the connection by the telephony network.

### BACKGROUND OF THE INVENTION

1. Field of the Invention

The present invention relates to the use of hands-free telephone technology in a fuel dispenser. The present invention allows a person to make a telephone call utilizing the fuel dispenser.

2. Description of the Related Art

May people use cellphones as a part of daily life. The use of a cellphone while dispensing fuel may be hazardous which has prompted some fuel dispenser station owners to place “no cellphone use” stickers on their fuel dispensers.

One invention currently available is a portable fueling facility for aircraft wherein the portable fueling facility has a phone attached to the facility. One problem is that the phone is not hands-free which can impede the fueling process because the cord can become tangled with the fuel dispensing hose. Another problem is that the phone only allows the user to speak with the service center for complaints or questions. A third problem is that the fueling facility is for aircraft and not for automobiles. The present invention solves these problems.

### SUMMARY OF THE INVENTION

The present invention, in one form thereof, is a hands-free communication system for a fuel dispenser connected to a telephony network. The system includes a fuel dispenser and a speaker connected to the fuel dispenser. Also, a microphone is connected to the fuel dispenser. A communication means is connected to the fuel dispenser for creating a connection to the telephony network by connecting together the speaker and the microphone with the telephony network.

The present invention, in another form thereof, is a hands-free communication system for a fuel dispenser connected to a telephony network. The system includes a fuel dispenser and a speaker connected to the fuel dispenser. Also, a microphone is connected to the fuel dispenser. An inputting means is connected to the fuel dispenser for inputting a telephone number. Finally, a communication means is connected to the fuel dispenser for creating a connection to the telephony network by connecting together the speaker, the inputting means and the microphone with the telephony network.

The present invention, in yet another form thereof, is a hands-free communication system for a fuel dispenser connected to a telephony network. The system includes a fuel dispenser and a speaker connected to the fuel dispenser. Also, a microphone is connected to the fuel dispenser. A payment means is connected to the fuel dispenser for receiving a payment from a user of the communication system. An inputting means is connected to the fuel dispenser for inputting a telephone number. Finally, a communication means is connected to the fuel dispenser for creating a connection to a telephony network by connecting together the speaker, the microphone and the inputting means with the telephony network.

The present invention, in yet another form thereof, is a hands-free communication system for a fuel dispenser connected to a telephony network. The system includes a fuel dispenser and a duplex means connected to the fuel dispenser for generating and amplifying sound. Also, the communication means is connected to the fuel dispenser for creating a connection to the telephony network by connecting together the duplex means with the telephony network.

The present invention, in yet another form thereof, is a method of hands-free communication for a fuel dispenser for connecting to a telephony network. The method includes the step of detecting the use of the fuel dispenser. The second step of the method is inputting the telephone number to be dialed. The final step of the method is activating a telephone connection to a telephony network.

An advantage of the present invention is that the potential hazard presented by the use of a cellphone while dispensing fuel into a vehicle is eliminated.

Another advantage of the present invention is that there is no telephone cord connected to the telephone so there is no chance of getting the telephone cord tangled with the fuel dispensing hose. Also, the present invention allows for local as well as long distance calls to be made and not merely calls to one particular destination.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a diagrammatic view of one form of the present invention; and

FIG. 2 is a diagrammatic view of another form of the present invention.

Corresponding reference characters indicate corresponding parts throughout the several views. The exemplification set out herein illustrates one preferred embodiment of the invention, in one form, and such exemplification is not to be construed as limiting the scope of the invention in any manner.

### DETAILED DESCRIPTION OF THE INVENTION

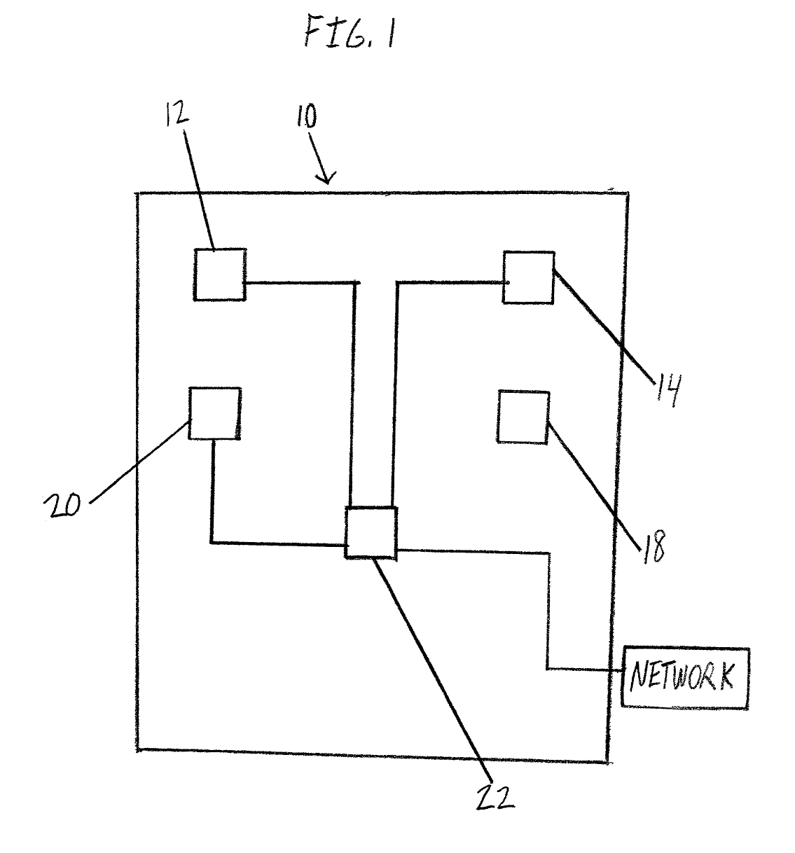

In one form of the present invention, as shown in FIG. 1, is a hands-free communication system for a fuel dispenser 10. Fuel dispenser 10 is connected to a speaker 12, a microphone 14, a payment means 18, an input means 20 and a communication means 22.

Fuel dispenser 10 connects to a telephony network utilizing communication means 22.

Communication means 22 is a network connection, such as the internet, to the telephony network. Voice over Internet Protocol (VoIP) is utilized to connect to the telephony network using a network connection. VoIP is utilized for the transmission of telephone calls over a data network. Many companies provide VoIP service and a list of some of those companies can be found on IP Telephony Online. The website address for IP Telephony Online is www.internet-telephony.org. The mailing address for IP Telephony Online is P.O. Box 18982, Anaheim, Calif. 92817-8982. Some companies that offer VoIP service are Net2Phone, located at 520 Broad Street, Newark, N.J., 07601, Deltathree, located at 76 Broad Street, 31^{st} Floor, New York, N.Y., 10004 and Inter-fone, located at 16 L Shrewsbury Green Drive, Shrewsbury, Mass. 01545. Communication means 22 can also be a dedicated telephone line. The use of the network or dedicated telephone line to connect to the telephony network is not meant to be limiting and other ways of connecting to the telephony network can be used as well.

Inputting means 20 is utilized to input a telephone number into communication means 22. Inputting means 20 is a keypad wherein the user of fuel dispenser 10 presses a number sequence on the keypad corresponding to the telephone number to be dialed. Inputting means 20 can also be a touch pad screen wherein the user of fuel dispenser 10 can touch the number sequence corresponding to the telephone number to be dialed. Also, inputting means 20 can be voice activated so that the user of fuel dispenser 10 orally communicates the number sequence corresponding to the telephone number to be dialed.

If inputting means 20 is voice activated, the user of fuel dispenser 10 can orally communicate the telephone number to be dialed without having to do anything more. In another form of the present invention, the communication system can be structured so that once fuel is being dispensed, fuel dispenser 10 will prompt the user with the option to make a telephone call. The user can respond to the prompt with “yes” followed by the telephone number to be dialed if the user wants to make a telephone call. Communication means 22 will then connect the user with the telephony network so that the user can communicate with another person, place, device or anything that has a telephone number. If the user of fuel dispenser 10 does not want to make a telephone call, the user can respond to the prompt with “no” and continue dispensing fuel. In another form of the invention, fuel dispenser 10 can have a sensor (not shown) to detect the presence of a person and once the person is detected, fuel dispenser 10 prompts the person with the option of making a telephone call. This list of inputting means is not meant to be limiting, and other types of inputting means can be used as well.

Speaker 12 and microphone 14 are utilized for communication with a person or place corresponding to the inputted telephone number. Microphone 14 generates sound and speaker 12 amplifies sound. Speaker 12 and microphone 14 can be one component or connected to separate areas on fuel dispenser 10.

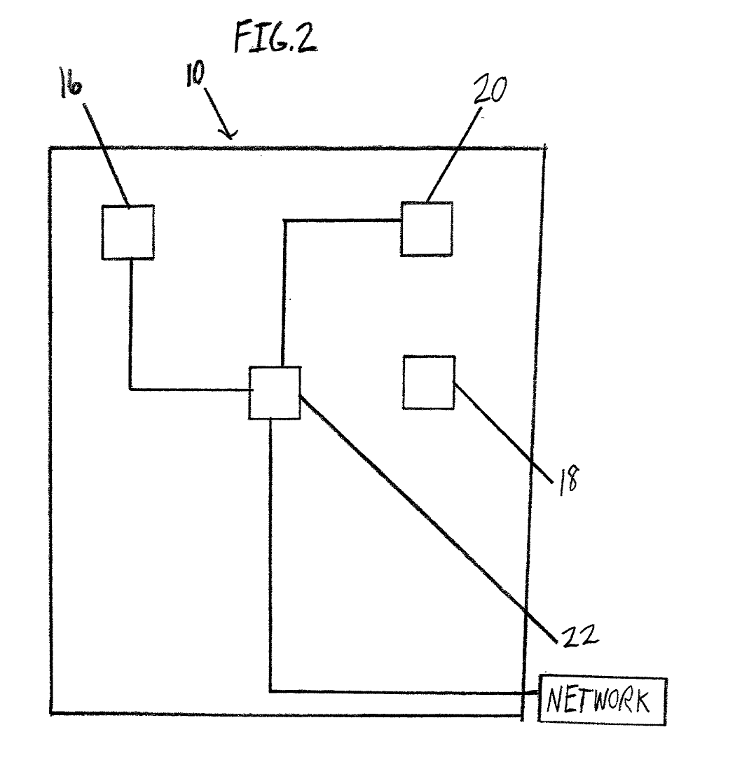

As shown in FIG. 2, a duplex means 16 can be utilized in place of speaker 12 and microphone 14. Duplex 16 could also be used together with speaker 12 and microphone 14. Duplex means 16 is used for generating sound transmitted to the telephony network and amplifying sound transmitted from the telephone network. Duplex means 16 is full duplex but can be half duplex as well. A full duplex device allows a user to talk and listen at the same time. A half duplex device allows a user to talk or listen but not both at the same time. Duplex means 16 is not limited to being half duplex or full duplex and can be any other type of duplex.

Payment means 18 is utilized to accept payment for the telephone call and/or fuel dispensed in the form of a credit card, telephone card, debit card or cash. Other forms of payment such as checks, Electronic Benefit Transaction Cards, Automated Teller Machine Cards, money orders and travelers checks can be used. Also, any other form of payment can be used as well. Payment means 18 is connected to a network (not shown) to ensure that adequate funds are in the user's account. Payment means 18 can be connected to communication means 22 to verify adequate funds as well. The option of payment means 18 being connected to communication means 22 is so that the adequate funds in the user's account can be verified before communication means 22 activates a telephone call. Payment is not necessary for 911 or toll-free calls.

If the user of fuel dispenser 10 prepays for the telephone call and/or fuel dispensed with a fixed sum of money such as a check, money order or cash, fuel dispenser 10 can have a change return (not shown) for use if the transaction amount is less than the amount prepaid by the user. An example would be if the user of fuel dispenser 10 writes a check for ten dollars and inserts the check into payment means 18 and the fuel dispensed in addition to the telephone call is eight dollars and seventy-five cents, then one dollar and twenty-five cents will be returned through the change return to the user of fuel dispenser 10. Also, the communication system can be structured so that the amount of change due to the user of fuel dispenser 10 is printed from a receipt printer (not shown) connected to fuel dispenser 10. In this case, the user of fuel dispenser 10 will take the receipt into the service station to receive change from the cashier. Payment can be made inside the fueling station as well.

The present invention is utilized by the person utilizing fuel dispenser 10. The communication system can be activated once the user of fuel dispenser 10 begins dispensing fuel into the user's vehicle or a container. The present invention is not limited to dispensing fuel and can be used with any dispensing apparatus. The communication system can also be used at any time and is not limited to only when fuel is being dispensed by the user of fuel dispenser 10.

The user utilizes inputting means 20 to input a telephone number to be dialed by communication means 22. Communication means 22 creates the connection with the telephony network, and once the connection is established, the user can have a hands-free conversation while dispensing fuel. Local, as well as long distance calls (including international calls), can be made if the owner of fuel dispenser 10 decides to structure the communication system in this manner. The communication system can allow for free local calls as well as free long distance or the system can be structured so that there are free local telephone calls and a charge for long distance telephone calls. The communication system can also be structured to have no free calls wherein both local and long distance calls will require payment by the user of fuel dispenser 10.

The present invention, in another form, is a method of hands-free communication for a fuel dispenser for connecting to a telephony network. The first step of the method is detecting the use of the fuel dispenser. This detection can occur either from the activation of the pump to dispense fuel or if a sensor is used and the sensor detects a person desiring to make a telephone call. Other types of detection methods can be utilized as well. The next step of the method is inputting the telephone number to be dialed. Based on the type of inputting method used, the telephone number can be entered into a keypad, entered by touching the numbers on a touch screen or if the inputting method is by voice activation, the user can orally communicate the telephone number to be dialed. The final step of the method is activating a telephone communication to a telephony network. This final step of the method can be completed using a dedicated telephone line to connect to the telephony network as well as using a network connection, such as the internet, to activate the telephone connection to the telephony network.

The communication system can also be used for promotional advertising. An example of an advertisement would be that if a user of the fuel dispenser purchases a predetermined amount of fuel, the user will get a free telephone call for a predetermined amount of minutes based on the amount of fuel purchased. Another example of a promotion could be that for each gallon of fuel purchased by the user of the fuel dispenser, the user gets one minute of calling time using the fuel dispenser. These examples are not meant to be limiting in any way and other combinations of fuel purchased corresponding to free telephone call minutes can be utilized. Also, other promotions for offering free or reduced priced telephone calls can be used as well.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A hands-free communication system for a fuel dispenser connected to a telephony network, said system comprising:
a fuel dispenser;
a speaker connected to said fuel dispenser;
a microphone connected to said fuel dispenser;
a payment means connected to said fuel dispenser for receiving a payment from a user of said communication system;
an inputting means connected to said fuel dispenser for inputting a telephone number; and
a communication means connected to said fuel dispenser for creating a connection to a telephony network, said communication means connecting together said speaker, said microphone and said inputting means with the telephony network.

2. The communication system in claim 1, wherein said inputting means is a keypad.

3. The communication system in claim 1, wherein said inputting means is a touchscreen.

4. The communication system in claim 1, wherein said inputting means is a voice activated.

5. The communication system in claim 1, wherein the payment by the user is completed utilizing a credit card.

6. The communication system in claim 1, wherein the payment by the user is completed utilizing a telephone card.

7. The communication system in claim 1, wherein the payment by the user is completed utilizing cash.

8. The communication system in claim 1, wherein said communication means is a dedicated telephone line.

9. The communication system in claim 1, wherein said communication means is a network connection.

10. The communication system in claim 9, wherein said network connection is the internet.

11. A hands-free communication system for a fuel dispenser connected to a telephony network, said system comprising:
a fuel dispenser;
a speaker connected to said fuel dispenser;
a microphone connected to said fuel dispenser;
an inputting means connected to said fuel dispenser for inputting a telephone number; and
a communication means connected to said fuel dispenser for creating a connection to a telephony network, said communication means connecting together said speaker, said inputting means and said microphone with the telephony network.

12. The communication system in claim 11, further comprising a payment means connected to said fuel dispenser for receiving payment from a user of said fuel dispenser.

13. The communication system in claim 11, wherein said inputting means is a keypad.

14. The communication system in claim 11, wherein said inputting means is a touch screen.

15. The communication system in claim 11, wherein said inputting means is voice activated.

16. The communication system in claim 12, wherein the payment by the user is completed utilizing a credit card.

17. The communication system in claim 12, wherein the payment by the user is completed utilizing a telephone card.

18. The communication system in claim 12, wherein the payment by the user is completed utilizing cash.

19. The communication system in claim 11, wherein said communication means is a network connection.

20. The communication system in claim 19, wherein said network connection is the internet.

21. The communication system in claim 11, wherein said communication means is a dedicated telephone line.

22. A hands-free communication system for a fuel dispenser connected to a telephony network, said system comprising:
a fuel dispenser;
a speaker connected to said fuel dispenser;
a microphone connected to said fuel dispenser; and
a communication means connected to said fuel dispenser for creating a connection to a telephony network, said communication means connecting together said speaker and said microphone with the telephony network.

23. The communication system in claim 22, further comprising a payment means connected to said fuel dispenser for receiving payment from a user of said fuel dispenser.

24. The communication system in claim 22, further comprising a inputting means connected to said fuel dispenser for inputting a telephone number.

25. The communication system in claim 24, wherein said inputting means is a keypad.

26. The communication system in claim 24, wherein said inputting means is a touchscreen.

27. The communication system in claim 24, wherein said inputting means is voice activated.

28. The communication system in claim 23, wherein the payment by the user is completed utilizing a credit card.

29. The communication system in claim 23, wherein the payment by the user is completed utilizing a telephone card.

30. The communication system in claim 23, wherein the payment by the user is completed utilizing cash.

31. The communication system in claim 22, wherein said communication means is a network connection.

32. The communication system in claim 31, wherein said network connection is the internet.

33. The communication system in claim 22, wherein said communication means is a dedicated telephone line.

34. A hands-free communication system for a fuel dispenser connected to a telephony network, said system comprising:
a fuel dispenser;
a duplex means connected to said fuel dispenser for 5 generating and amplifying sound; and
a communication means connected to said fuel dispenser for creating a connection to a telephony network, said communication means connecting together said duplex means with the telephony network.

35. The communication system in claim 34, further comprising a payment means connected to said fuel dispenser for receiving payment from a user of said fuel dispenser.

36. The communication system in claim 34, further comprising a inputting means connected to said fuel dispenser for inputting a telephone number.

37. The communication system in claim 34, wherein said duplex means is full duplex.

38. The communication system in claim 34, wherein said duplex means is half duplex.

39. The communication system in claim 34, wherein said communication system is activated when said fuel dispenser is activated.

40. The communication system in claim 36, wherein said inputting means is a keypad.

41. The communication system in claim 36, wherein said inputting means is a touchscreen.

42. The communication system in claim 36, wherein said inputting means is voice activated.

43. The communication system in claim 35, wherein the payment by the user is completed utilizing a credit card.

44. The communication system in claim 35, wherein the payment by the user is completed utilizing a telephone card.

45. The communication system in claim 35, wherein the payment by the user is completed utilizing cash.

46. The communication system in claim 34, wherein said communication means is a network connection.

47. The communication system in claim 46, wherein said network connection is the internet.

48. The communication system in claim 34, wherein said communication means is a dedicated telephone line.

49. A method of hands-free communication for a fuel dispenser for connecting to a telephony network, said method comprising:
detecting the use of said fuel dispenser;
inputting the telephone number to be dialed; and
activating a telephone connection to a telephony network.
